(19) United States
(12) Patent Application Publication
(10) Pub. No.: US 2006/0159340 A1
(43) Pub. Date: Jul. 20, 2006

(54) Digital image photographing apparatus and method

(75) Inventor: Eun Sil Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/305,774

(22) Filed: Dec. 15, 2005

(30) Foreign Application Priority Data
Dec. 15, 2004 (KR) 10-2004-0106617

(51) Int. Cl. G06K 9/00

(52) U.S. Cl. 382/169

(57) ABSTRACT

A digital image photographing apparatus includes: a histogram calculating part for calculating a histogram of an inputted original image; a histogram value setting part for selecting an upper range in a first ratio in the histogram to set a lowest limit value as a maximum brightness value of the original image, and selecting a lower range in a second ratio to set a highest limit value as a minimum brightness value of the original image; a parameter setting part for setting a minimum brightness value of a processed image to a value less than the minimum brightness value of the original image, and setting a maximum brightness value of the processed image to a value greater than the maximum brightness value of the original image; and a histogram stretching part for stretching the histogram of the original image with reference to the maximum and minimum values of the processed image.

This application claims the benefit of the Korean Patent Application No. 10-2004-0106617, filed on Dec. 15, 2004, which is hereby incorporated by reference as if fully set forth herein.

### BACKGROUND OF THE INVENTION

1. Field of the Invention

The present invention relates to a digital image photographing apparatus and method.

2. Description of the Related Art

Recently, the use of digital photographing apparatus, such as a mobile communication terminal with a camera, a digital camcorder, a digital camera, is gradually expanded.

Such a digital image photographing apparatus has a preview function. The preview function is a function that sequentially displays images inputted to a lens in real time in order to allow the user to select a predetermined image by pressing a shutter.

In an analog camera, a viewfinder directly transmits an image reflected on a lens to human's eyes. On the contrary, a digital image photographing apparatus provides a preview image by repeatedly performing the operation of converting an input image into a digital image data and processing the converted digital image data. Generally, the preview image is provided with several to tens of frames per second.

Therefore, in providing the preview image, the digital image photographing apparatus is different from the viewfinder of the analog camera. Several problems exist due to the structural characteristics.

For example, if the digital image photographing apparatus or an object momentarily moves from a region having a large gray-scale difference to a region having a small gray-scale difference with respect to a series of preview images, or vice versa, the displayed preview image becomes unnatural.

Likewise, when the brightness momentarily changes greatly, the image connection of the respective frames in the preview image becomes poor.

In order to solve these problems, an apparatus for enhancing a picture quality through an image processing is used. For example, the picture quality of the preview images can be enhanced through a histogram stretching process. Also, the picture quality can be enhanced by changing an output gray-scale value corresponding to the input using a histogram smoothing scheme and a local histogram smoothing scheme.

However, the above methods consider only the frames of the preview image but do not reflect their continuity and thus the above problems exist still.

FIG. 1 is a diagram illustrating a method of enhancing a picture quality of an image using a related art histogram stretching process.

In FIG. 1, a horizontal axis represents a brightness degree in each pixel, and a vertical axis (not shown) represents a value of a probability density function.

Referring to FIG. 1, a maximum value and a minimum value of the brightness degree are set in a histogram distribution of an original image, and respective values are stretching-processed with respect to the maximum brightness value and the minimum brightness value of the processed image. Here, since the maximum brightness value and the minimum brightness value of the processed image are fixed, the satisfactory image processing cannot be expected in the rapidly-changing preview images.

FIG. 2 is a diagram illustrating a method of enhancing a picture quality of an image using a related art histogram stretching processing.

An original image of FIG. 2 has a narrow distribution range than that of the original of FIG. 1. When the original image is expanded to the fixed maximum brightness value and minimum brightness value of the processed image, the contrast of the processed image is enhanced. However, the range is expanded excessively, thus obtaining to an unstable image. If the contrast is expanded excessively, the image outputted with a plurality of frames per second may be flickered so that it is recognized unstably.

FIG. 3 is a diagram illustrating a method of enhancing a picture quality of an image using a related art histogram stretching process.

Referring to FIG. 3, a histogram distribution of an original image leans toward a dark region. If the original image is expanded to the fixed maximum brightness value and minimum brightness value of the processed image, the processed image is exaggerated too much and thus displayed brightly. In this case, since the degree of the brightness of the original images is not reflected, there occurs a phenomenon that becomes too bright or too dark at a moment. The user feels uncomfortable when reviewing the photographed image through the preview screen.

Therefore, there is a demand for an image processing technique that can display a preview image naturally and equally to the original image when the gray scale region of the preview image rapidly changes or its brightness rapidly changes.

Also, there is a demand for an image processing technique that can enhance a picture quality to match the continuity of preview images by containing unstable factors in image processing variables in the preview images that is being displayed at a fast speed without being limited to one screen.

### SUMMARY OF THE INVENTION

Accordingly, the present invention is directed to a digital image photographing apparatus and method that substantially obviates one or more problems due to limitations and disadvantages of the related art.

An object of the present invention is to provide a digital image photographing apparatus and method, capable of preventing an image from being unnatural and enhanced too excessively than an original image when a gray scale region of a preview image rapidly changes or a brightness rapidly changes by using maximum and minimum parameters flexibly adjusted according to a photographing environment, instead of using fixed maximum and minimum brightness value parameters.

Another object of the present invention is to provide a digital image photographing apparatus and method, capable of reflecting characteristics of each image and considering the continuity of a preview image by selectively performing an image processing operation according to the photographing environment in the divided image processing operations and flexibly moving the maximum and minimum brightness value parameters while reflecting the photographing environment in each image processing operation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a digital image photographing apparatus including: a histogram calculating part for calculating a histogram of an inputted original image; a histogram value setting part for selecting an upper range in a first ratio in the histogram to set a lowest limit value as a maximum brightness value of the original image, and selecting a lower range in a second ratio to set a highest limit value as a minimum brightness value of the original image; a parameter setting part for setting a minimum brightness value of a processed image to a value less than the minimum brightness value of the original image, and setting a maximum brightness value of the processed image to a value greater than the maximum brightness value of the original image; and a histogram stretching part for stretching the histogram of the original image with reference to the maximum and minimum values of the processed image.

In another aspect of the present invention, there is provided a digital image photographing apparatus including: a histogram calculating part for calculating a histogram of an inputted original image; a histogram value setting part for setting maximum and minimum brightness values of the original image in the histogram; a first parameter setting part for setting a first minimum brightness value of a processed image to a value less than the minimum brightness value of the original image, and setting a first maximum brightness value of the processed image to a value greater than the maximum brightness value of the original image; a second parameter setting part for setting second maximum and minimum brightness values according to difference between the maximum and minimum brightness values of the original image; and a histogram stretching part for stretching the histogram of the original image with reference to the second maximum and minimum brightness values of the processed image.

In a further another aspect of the present invention, there is provided a digital image photographing apparatus including: a histogram calculating part for calculating a histogram of an inputted original image; a histogram value setting part for setting maximum and minimum brightness values of the original image in the histogram; a first parameter setting part for setting a first minimum brightness value of a processed image to a value less than the minimum brightness value of the original image, and setting a first maximum brightness value of the processed image to a value greater than the maximum brightness value of the original image; a second parameter setting part for setting second maximum and minimum brightness values according to a difference between the maximum and minimum brightness values of the original image; a third parameter setting part for setting third maximum and minimum brightness values according to a brightness of the second maximum and minimum brightness values; and a histogram stretching part for stretching the histogram of the original image with reference to the third maximum and minimum brightness values of the processed image.

In a still further another aspect of the present invention, there is provided a digital image photographing method including: calculating a histogram of an inputted original image; setting maximum and minimum brightness values of the original image; setting a first minimum brightness value of a processed image to a value less than the minimum brightness value of the original image, and setting a first maximum brightness value of the processed image to a value greater than the maximum brightness value of the original image; setting second maximum and minimum brightness values according to a difference between the maximum and minimum brightness values of the original image; setting third maximum and minimum brightness values according to a brightness of the second maximum and minimum brightness values; and stretching the histogram of the original image with reference to the third maximum and minimum brightness values of the processed image.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a method of enhancing a picture quality of an image using a related art histogram stretching process;

FIG. 2 is a diagram illustrating a method of enhancing a picture quality of an image using a related art histogram stretching process;

FIG. 3 is a diagram illustrating a method of enhancing a picture quality of an image using a related art histogram stretching process;

FIG. 4 is a block diagram of a digital image photographing apparatus according to the present invention; and

FIG. 5 is a flowchart illustrating a histogram stretching method of the digital image photographing apparatus according to the present invention.

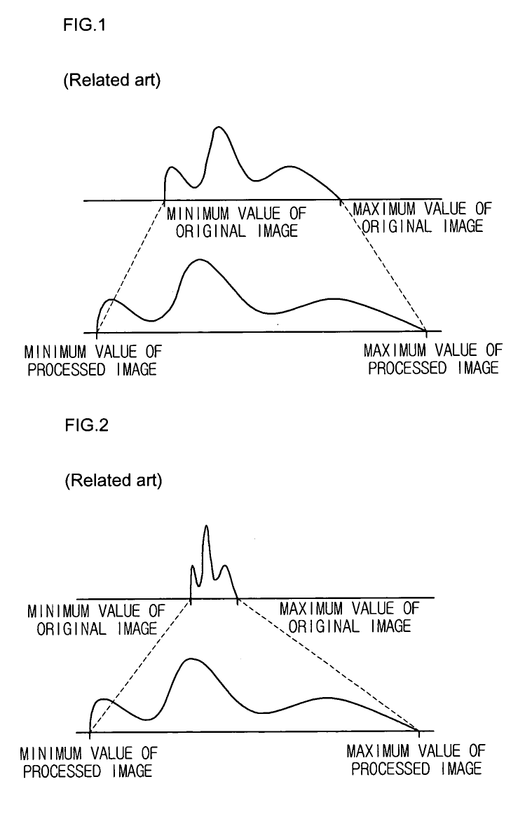

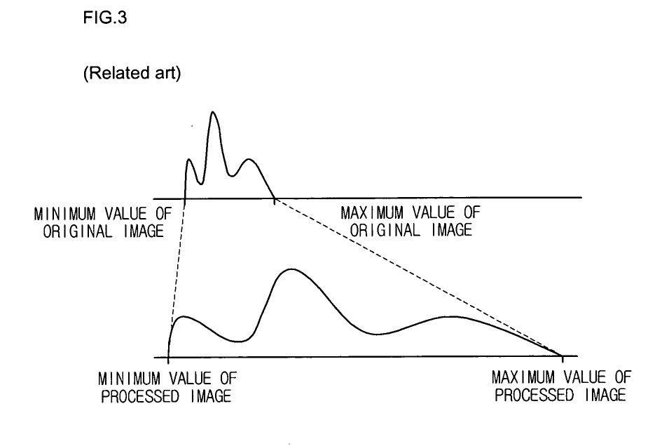

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a digital image photographing apparatus according to an embodiment of the present invention will be described in detail with reference to the accompanying drawings.

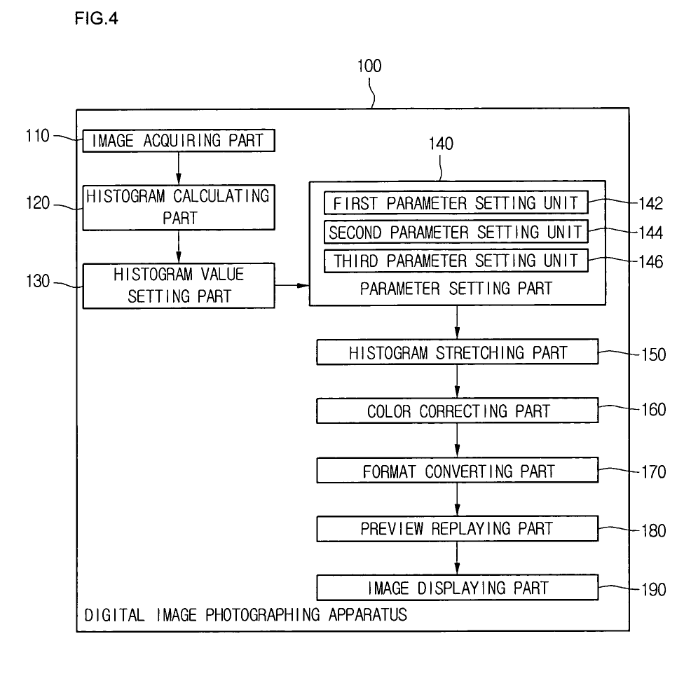

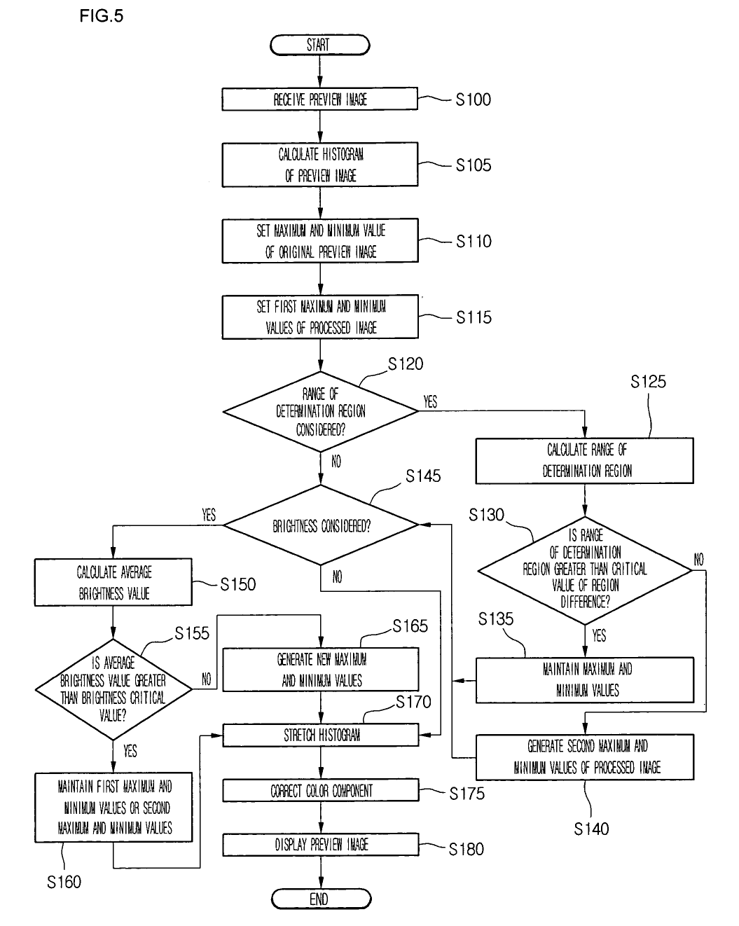

FIG. 4 is a block diagram of a digital image photographing apparatus 100 according to an embodiment of the present invention.

Referring to FIG. 4, the digital image photographing apparatus 100 includes an image acquiring part 110, a histogram calculating part 120, a histogram value setting part 130, a parameter setting part 140, a histogram stretching part 150, a color correcting part 160, a format converting part 170, a preview replaying part 180, and an image displaying part 190.

The image acquiring part 110 can include a lens, a sensor, and a digital signal processor (DSP). Light signal on the lens is digitalized through the sensor, and the DSP reconstructs the digital data in a specific color space such as RGB, YUV (brightness, in-phase, quadrature), and HSI (hue, saturation, brightness).

The image inputted from the image acquiring part 110 is processed by the preview replaying part 180, and the image displaying part 190 displays the processed image in real time.

Through these processes, the user can select desired images while monitoring the screen. The image inputted from the image acquiring part 110 in real time has 10-15 frames per second.

The histogram calculating part 120 calculates the histogram of the preview image inputted from the image acquiring part 110 in real time. Here, the histogram is obtained by graphing the function of calculating the pixel distribution in each gray scale in the preview image. The calculation of the histogram is a pre-processing that is necessary to determine a maximum brightness value, a minimum brightness value, a light level of an image, which are used in the stretching process.

The histogram value setting part 130 selects an upper range at a predetermined ratio in the histogram of the preview image, sets a lowest limit value as the maximum brightness value of the original image. Also, the histogram value setting part 130 selects a lower range at a predetermined ratio and sets a highest limit value as the minimum brightness value of the original image.

The histogram value setting part 130 selects an upper range at a ratio of 5% in the histogram and sets the smallest brightness value, which is 5% or more, as the maximum brightness value of the original image. Also, the histogram value setting part 130 selects a lower range at a ratio of 10% in the histogram and sets the largest brightness value, which is 10% or less, as the minimum brightness value of the original image.

The parameter setting part 140 includes a first parameter setting unit 142, a second parameter setting unit 144, and a third parameter setting unit 146. In some cases, the parameters of the preview image are set through several steps.

The reason why the parameters are set through several steps is that the preview image is inputted in real time and often has a poor picture quality, unlike the image finally selected by pressing a shutter.

Therefore, in order to pre-process the preview image, the parameter setting part 140 includes three parameter setting units according to its function.

The first parameter setting unit 142 sets a first minimum brightness value of the processed image to a value less than the minimum brightness value of the original image, and a first maximum brightness value of the processed image to a value greater than the maximum brightness value of the original image. Here, the processed image means an image whose image component is stretched with reference to the maximum and minimum values adjusted more greatly than the original image.

If setting the first minimum and maximum brightness values, the contrast increases.

Considering the range of the determination region of the original image (the difference between the maximum brightness value and the minimum brightness value), if it is determined that the range of the determination region is too small, the second parameter setting unit 114 resets the first maximum and minimum brightness values of the processed image.

That is, when the range of the determination region is less than a critical value of a predetermined region difference, the second parameter setting unit 144 resets the first maximum and minimum brightness values of the processed image. on the contrary, when the range of the determination region is greater than the critical value, the second parameter setting unit 144 maintains the first maximum and minimum brightness values of the processed image set by the first parameter setting unit 142.

In other words, the case where the range of the determination region is less than the critical value means that the histogram distribution region of the corresponding preview image is narrow. At this time, if the pixel values of the preview image are excessively stretched, the image may be distorted. Therefore, the first maximum and minimum brightness values used as the reference of the stretching are reset.

The second parameter setting unit 144 sets the second minimum and maximum brightness values using Eqs. (1) and (2) below.
second maximum brightness value=Ratio×(first maximum brightness value)+(1−Ratio)×(maximum brightness value of original image) (1)
where, Ratio=|(maximum brightness value of original image)−(minimum brightness value of original image)|÷(critical value of region difference)
   second minimum brightness value=Ratio×(first minimum brightness value)+(1−Ratio)×(minimum brightness value of original image) (2)
where, Ratio=|(maximum brightness value of original image)−(minimum brightness value of original image)|÷(critical value of region difference)

Eq. (1) is an equation for calculating the second maximum brightness value, and Eq. (2) is an equation for calculating the second minimum brightness value. For example, the second parameter setting unit 144 can set the critical value of the region difference to 56.

It can be seen from the analysis of Eqs. (1) and (2) that as the range of the determination range is closer to the critical value of the region difference, the second maximum and minimum brightness values are set to be close to the first maximum and minimum brightness values. For example, assuming that the range of the determination region is equal to the critical value of the region difference, the second maximum and minimum brightness values are maintained at the first maximum and minimum brightness values. Like this, as the range of the determination region is narrower, the second maximum and minimum values is close to the maximum and minimum brightness values of the original image, thereby preventing the phenomenon that the original image is corrected unstably.

Meanwhile, the third parameter setting unit 146 resets the first maximum and minimum brightness values and the second maximum and minimum brightness values as new third maximum and minimum brightness values, considering the entire brightness of the preview image.

Hereinafter, it is assumed that the second parameter setting unit 144 sets the second maximum and minimum brightness values and resets the values to the third maximum and minimum values.

However, it should be noted the first maximum and minimum brightness values can be reset to the third maximum and minimum brightness values without changing to the second maximum and minimum brightness values, and can be stretched while maintaining the initial values according to the characteristics of the preview image.

In setting the maximum and minimum parameters of the processed image, if it is set to consider the range of the determination region, the third parameter setting unit 146 calculates the second maximum and minimum brightness values of the processed image and compares them with a predetermined brightness reference (brightness critical value). The third parameter setting unit 146 can provide the brightness degree of the image by calculating an intermediate value of the second maximum and minimum brightness values of the processed image.

If it is determined that an average value of the second maximum and minimum brightness values is less than the brightness critical value, the third parameter setting unit 146 generates third maximum and minimum brightness values by reflecting the brightness critical value, the brightness value of the image, and a proportional value into the second maximum and minimum brightness values of the processed image.
third maximum brightness value=second maximum brightness value+positive proportional value×(brightness critical value−brightness value of original image) (3)
third minimum brightness value=second minimum brightness value+positive proportional value×(brightness critical value−brightness value of original image) (4)

The third parameter setting unit 146 generates the third maximum brightness value using Eq. (3) and the third minimum brightness value using Eq. (4).

In this embodiment, the brightness critical value in Eqs. (3) and (4) is set to 50, and the positive proportional value is set to 3-5.

The third parameter setting unit 146 can provide the differentiated brightness adjustment in proportion to the brightness of the original image by the above calculating operation.

The histogram stretching part 150 digitalizes the image by stretching the histogram of the preview image with reference to the finally set minimum and maximum parameters.

Here, the stretching process of the histogram of the preview image is related to brightness component of the color space. If the brightness component is stretched, it is preferable that other components should be corrected.

That is, assuming that a YUV model is used in the digital image photographing apparatus 100 of the present invention, if Y component (brightness) is stretched as described above, it is better to correct U component (in-phase as chrominance component) and V (quadrature as chrominance component) according to the Y component.

For the same reason, the color correcting part 160 calculates the ratio of the expanded region as the maximum and minimum value of the original preview image are finally stretched to the third maximum and minimum brightness values.

The color correcting part 160 corrects the U and V components according to the calculated ratio. Generally, since bits are allocated to YUV in the ratio of 4:2:2, the correction can be performed by applying the ratio of the allocated bits to the ratio of the expanded region.

If the brightness component of the preview image is stretched by about 20%, the chrominance component can be stretched by 10%.

The format converting part 170 receives the processed image from the histogram stretching part 150 or, if corrected, from the color correcting part 160, and converts a format of the image into a predetermined format (e.g., Joint Photographic Experts Group (JPEG)) used in the digital image photographing apparatus 100 of the present invention.

The preview replaying part 180 receives the processed image from the histogram stretching part 150 and replays it in real time, and the image displaying part 190 controls the liquid crystal display (LCD) to display the preview image.

Hereinafter, a driving method of the digital image photographing apparatus according to an embodiment of the present invention will be described in detail with reference to FIG. 5.

FIG. 5 is a flowchart illustrating a histogram stretching method of the digital image photographing apparatus according to the present invention.

Referring to FIG. 5, in operations S100 and S105, when a series of preview images are inputted through the image acquiring part 110, the histogram calculating part 120 calculates the histogram of the preview images.

In operation S110, the histogram value setting part 130 selects an upper range in a predetermined ratio on the histogram and sets the lowest limit value as the maximum brightness value of the original image, and selects a lower range in a predetermined ratio and sets the highest limit value as the minimum brightness value of the original image.

In operation S115, as the maximum and minimum brightness values of the original preview image, the first parameter setting unit 142 sets the first minimum brightness value of the processed image to a value less than the minimum brightness value of the original image, and the first maximum brightness value of the processed image to a value greater than the maximum brightness value of the original image.

In operations S120 and S130, when the second parameter setting unit 144 sets the parameters of the maximum and minimum brightness values of the processed image so that the range of the determination region is considered, the second parameter setting unit 144 calculates the range of the determination region. Then, in operation S130, the second parameter setting unit 144 compares the range of the determination region with the critical value of the region difference.

In operation S135, if the range of the determination region is greater than the critical value, the second parameter setting unit 144 maintains the first maximum and minimum brightness values without any change.

On the contrary, in operation S140, if the range of the determination region is less than the critical value in operation S130, the second parameter setting unit 144 changes the first maximum and minimum brightness values to generate new second maximum and minimum brightness values.

At this time, the second parameter setting unit 144 calculates the maximum and minimum brightness values of the original image and the ratio of the critical value of the region difference, and applies the calculated values to the minimum brightness value of the original image and the first minimum brightness value to thereby generate the second minimum brightness value of the processed image.

Likewise, the second parameter setting unit 144 generates new second maximum brightness value by applying the ratio to the maximum brightness value of the original image and the first maximum brightness value.

Also, in operations S145 and S150, when the third parameter setting unit 146 sets the parameters of the maximum and minimum brightness values of the processed image so that the range of the determination region is considered, the third parameter setting unit 146 calculates an average value of the brightness according to the second maximum and minimum brightness values of the processed image and compares them with the brightness critical value.

However, if the brightness of the image is not considered, or the range of the determination region is greater than the critical value of the region difference, the third parameter setting unit 146 calculates the average value of the brightness by applying the first maximum and minimum brightness values instead of the second maximum and minimum brightness values.

In operations S155 and S165, if the average value is less than the brightness critical value, the third parameter setting unit 146 reflects the brightness critical value, the brightness value of the image, and the proportional value into the second maximum and minimum brightness values of the processed image to generate new third maximum and minimum brightness values.

On the contrary, if the average value is greater than the brightness critical value, the third parameter setting unit 146 maintains the second maximum and minimum brightness values without setting new maximum and minimum brightness values.

Meanwhile, in case where the range of the determination region is greater than the critical value of the region difference and thus the first maximum and minimum brightness values are maintained as they are, the third parameter setting unit 146 calculates new maximum and minimum brightness values by reflecting the first maximum and minimum brightness values instead of the second maximum and minimum brightness values.

In operation S170, if the parameters of the maximum and minimum brightness values are finally adjusted, the histogram stretching part 150 processes the image by stretching the brightness component of the preview image with reference to the adjusted maximum and minimum brightness values. In operation S175, the color correcting part 160 corrects the color components in a predetermined ratio according to the brightness component.

Finally, the preview replaying part 180 replays the preview image passing through the pre-processing operation, and the image displaying part 190 displays the image according to the command outputted from the preview replaying part 180.

According to the digital image photographing apparatus of the present invention, it is possible to prevent a series of preview images from being recognized unstably.

Also, the preview images are displayed stably and continuously. The image is processed to be close to the original image without being excessively enhanced, and thus the preview image can be monitored comfortably and the optimal photographed images can be selected.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A digital image photographing apparatus comprising:
a histogram calculating part for calculating a histogram of an inputted original image;
a histogram value setting part for selecting an upper range in a first ratio in the histogram to set a lowest limit value as a maximum brightness value of the original image, and selecting a lower range in a second ratio to set a highest limit value as a minimum brightness value of the original image;
a parameter setting part for setting a minimum brightness value of a processed image to a value less than the minimum brightness value of the original image, and setting a maximum brightness value of the processed image to a value greater than the maximum brightness value of the original image; and
a histogram stretching part for stretching the histogram of the original image with reference to the maximum and minimum values of the processed image.

2. The digital image photographing apparatus according to claim 1, wherein the parameter setting part determines the maximum and minimum brightness values according to difference between the maximum and minimum brightness values of the original image.

3. The digital image photographing apparatus according to claim 1, further comprising a color correcting part for correcting a color component of the image according to the brightness stretched by the histogram stretching part.

4. A digital image photographing apparatus comprising:
a histogram calculating part for calculating a histogram of an inputted original image;
a histogram value setting part for setting maximum and minimum brightness values of the original image in the histogram;
a first parameter setting part for setting a first minimum brightness value of a processed image to a value less than the minimum brightness value of the original image, and setting a first maximum brightness value of the processed image to a value greater than the maximum brightness value of the original image;
a second parameter setting part for setting second maximum and minimum brightness values according to difference between the maximum and minimum brightness values of the original image; and
a histogram stretching part for stretching the histogram of the original image with reference to the second maximum and minimum brightness values of the processed image.

5. The digital image photographing apparatus according to claim 4, wherein the histogram value setting part selects an upper range in a first ratio to set a lowest limit value as the maximum brightness value of the original image, and selects a lower range in a second ratio to set a highest limit value as the minimum brightness value of the original image.

6. The digital image photographing apparatus according to claim 4, wherein the second parameter setting part resets the first maximum and minimum brightness values when a difference between the maximum and minimum brightness values of the original image is less than a critical value, and maintains the first maximum and minimum brightness values to the second maximum and minimum brightness values when the difference between the maximum and minimum brightness values of the original image is greater than the critical value.

7. The digital image photographing apparatus according to claim 4, wherein the second maximum brightness value is calculated by
Ratio×(the first maximum brightness value)+(1−Ratio)×(the maximum brightness value of the original image),
where, Ratio=|(maximum brightness value of original image)−(minimum brightness value of original image)|÷(critical value of region difference).

8. The digital image photographing apparatus according to claim 4, wherein the second minimum brightness value is calculated by
Ratio×(the first minimum brightness value)+(1−Ratio)×(the minimum brightness value of the original image).
where, Ratio=|(maximum brightness value of original image)−(minimum brightness value of original image)|÷(critical value of region difference)

9. The digital image photographing apparatus according to claim 4, further comprising a color correcting part for correcting a color component of the image according to the brightness stretched by the histogram stretching part.

10. A digital image photographing apparatus comprising:
a histogram calculating part for calculating a histogram of an inputted original image;
a histogram value setting part for setting maximum and minimum brightness values of the original image in the histogram;
a first parameter setting part for setting a first minimum brightness value of a processed image to a value less than the minimum brightness value of the original image, and setting a first maximum brightness value of the processed image to a value greater than the maximum brightness value of the original image;
a second parameter setting part for setting second maximum and minimum brightness values according to a difference between the maximum and minimum brightness values of the original image;
a third parameter setting part for setting third maximum and minimum brightness values according to a brightness of the second maximum and minimum brightness values; and
a histogram stretching part for stretching the histogram of the original image with reference to the third maximum and minimum brightness values of the processed image.

11. The digital image photographing apparatus according to claim 10, wherein the third maximum brightness value is calculated by
(the second maximum brightness value)+(positive proportional value)×(brightness critical value−brightness value of the original image).

12. The digital image photographing apparatus according to claim 10, wherein the third minimum brightness value is calculated by
(the second minimum brightness value)+(positive proportional value)×(brightness critical value−brightness value of the original image).

13. The digital image photographing apparatus according to claim 10, further comprising a color correcting part for correcting a color component of the image according to the brightness stretched by the histogram stretching part.

14. A digital image photographing method comprising:
calculating a histogram of an inputted original image;
setting maximum and minimum brightness values of the original image;
setting a first minimum brightness value of a processed image to a value less than the minimum brightness value of the original image, and setting a first maximum brightness value of the processed image to a value greater than the maximum brightness value of the original image;
setting second maximum and minimum brightness values according to a difference between the maximum and minimum brightness values of the original image;
setting third maximum and minimum brightness values according to a brightness of the second maximum and minimum brightness values; and
stretching the histogram of the original image with reference to the third maximum and minimum brightness values of the processed image.

15. The digital image photographing method according to claim 14, further comprising correcting a color component of the image according to the brightness stretched by the histogram stretching part.

16. The digital image photographing method according to claim 14, wherein the second maximum brightness value is calculated by
Ratio×(the first maximum brightness value)+(1−Ratio)×(the maximum brightness value of the original image),
where, Ratio=|(maximum brightness value of original image)−(minimum brightness value of original image)|÷(critical value of region difference).

17. The digital image photographing method according to claim 14, wherein the second minimum brightness value is calculated by
Ratio×(the first minimum brightness value)+(1−Ratio)×(the minimum brightness value of the original image)
where, Ratio=|(maximum brightness value of original image)−(minimum brightness value of original image)|÷(critical value of region difference).

18. The digital image photographing method according to claim 14, wherein the third maximum brightness value is calculated by
(the second maximum brightness value)+(positive proportional value)×(brightness critical value−brightness value of the original image).

19. The digital image photographing method according to claim 14, wherein the third minimum brightness value is calculated by
(the second minimum brightness value)+(positive proportional value)×(brightness critical value−brightness value of the original image).
